(19) United States
(12) Patent Application Publication
(10) Pub. No.: US 2012/0026336 A1
(43) Pub. Date: Feb. 2, 2012

(54) METHOD AND SYSTEM OF ENHANCED INTEGRATION OF MILLIMETER WAVE IMAGERY

(75) Inventors: Iztok KOREN, Lake Mary, FL (US); Ludwik TURZANSKI, Lake Mary, FL (US)

(73) Assignee: BRIJOT IMAGING SYSTEMS, INC., LAKE MARY, FL (US)

(21) Appl. No.: 12/846,240

(22) Filed: Jul. 29, 2010

(51) Int. Cl. G01S 15/89

(52) U.S. Cl. 348/163; 348/E07.091

(57) ABSTRACT

A method and system of enhanced integration of millimeter wave imagery is disclosed. In a particular embodiment, the method includes performing a first scan of millimeter wave energy of a target and processing the first scan of millimeter wave energy to generate millimeter wave imagery of the target. The method also includes displaying a video image and the millimeter wave imagery of the target on a video monitor and determining whether the target is still or moving. In addition, the method includes processing a second scan of the millimeter wave energy of the target when the target is still and not moving and integrating the first scan and the second scan to increase a resolution of the millimeter wave imagery.

### I. FIELD

The present invention relates in general to the field of concealed object detection systems, and in particular to a method and system of enhanced integration of millimeter wave imagery.

### II. DESCRIPTION OF RELATED ART

Security systems can be found at airports, train stations, arenas, construction sites, and other public, private, commercial and industrial facilities. In addition, security systems are used in harsh environments such as border control or field military operations. A passive millimeter wave camera is one type of concealed object detection system (“CODS”). The passive millimeter wave camera detects radiation that is given off by all objects. The technology works by contrasting the millimeter wave signature of the human body, which is warm and reflective, against that of a gun, knife or other contraband. Those objects appear in contrast because of the differences in temperature, hence, millimeter wave energy, between the human body and the inanimate objects.

The harsh and uncontrolled environments require that the prior art CODS must be adapted for each installation to provide the proper contrast between the environment and a subject so that the camera can detect concealed objects, which is expensive and time consuming. Further, personnel must be trained to operate the CODS for each different installation environment. Hence, a need exists in the art for a system for an enhanced resolution portable scanner (“ERPS”) that simplifies training and ease of use by using a similar deployment for each installation. A need also exists in the art for a system that eliminates the need to adapt the millimeter wave camera(s) to an uncontrolled environment so that the system can provide rapid “on demand” deployment and that eliminates the need to custom engineer a deployment for each application. Another need exists for enhanced resolution of the millimeter wave imagery.

Another shortcoming is that the prior art CODS are dependent on existing utilities and on-site support, which is not always available for the CODS installation in a harsh environment. Accordingly, what is needed is a system of enhanced integration of millimeter wave imagery that eliminates the need for services to support a millimeter wave camera such as air conditioning or other utilities and is not dependent on an external power source but has an independent power source.

Another need exists in the art for a method and system of enhanced integration of millimeter wave imagery that provides a stable, standard platform for deployments across extremely variable environments, resulting in lower installation costs and time, and simpler construction and support due to the standardized methodology.

Another need exists in the art for a method and system of enhanced integration of millimeter wave imagery that allows for a realization of manufacturing, engineering and procurement cost savings due to economies of scale.

However, in view of the prior art at the time the present invention was made, it was not obvious to those of ordinary skill in the pertinent art how the identified needs could be fulfilled.

### III. SUMMARY

In a particular embodiment, a method and system of enhanced integration of millimeter wave imagery is disclosed. The disclosed system is an approach for deploying a portable, self-contained, rapid deployment, millimeter wave camera using pre-engineered and pre-manufactured components to effectively increase the resolution of millimeter wave imagery. The system includes a case having side walls about its periphery and a millimeter wave camera contained within the case, where the millimeter wave camera is configured to scan a target subject multiple times to generate millimeter wave imagery. A video monitor displays the millimeter wave imagery of the target subject. The millimeter wave camera is configured to integrate at least two scans of the target subject to generate an enhanced millimeter wave imagery having an increase in resolution when the target subject is not moving. An independent power source may be used to provide power to the system. In addition, the case may include a handle disposed along a rear edge and a rolling means disposed about a rear sidewall of the case and configured to roll the case. The millimeter wave camera may include a twenty-four pixel radiometer. A personal computer may be used to control and operate the millimeter wave camera and the video monitor. The resolution of the millimeter wave imagery may be at least 1.6 inches by 1.6 inches. At least one millimeter wave backdrop may be removably secured to the case and adapted to provide a contrast between the target subject and a background scene when installed behind the target subject. The case may also include a swing door that opens to reveal the millimeter wave camera and a storage compartment.

In another particular embodiment, the method includes performing a first scan of millimeter wave energy of a target and processing the first scan of millimeter wave energy to generate millimeter wave imagery of the target. The method also includes displaying a video image and the millimeter wave imagery of the target on a video monitor and determining whether the target is still or moving. In addition, the method includes processing a second scan of the millimeter wave energy of the target when the target is still and not moving and integrating the first scan and the second scan to increase a resolution of the millimeter wave imagery.

One particular advantage provided by embodiments of the method and system of enhanced integration of millimeter wave imagery is the highly portable, “on demand” design and construction. Deployment time is measured in minutes instead of hours or days. Another particular advantage provided by embodiments of the system is that the need to adapt the system's cameras to an uncontrolled environment is eliminated. In addition, the method and system of enhanced integration of millimeter wave imagery can operate as either an entry portal for weapons or contraband detection or as an exit portal for theft prevention or both.

Another particular advantage provided by embodiments of the method and system of enhanced integration of millimeter wave imagery is its ability for rapid deployment and its minimal footprint and deployment requirements. Accordingly, the deployment of the millimeter wave equipment is completed without tools, simplifying and speeding deployment and re-deployment. Further, the millimeter wave equipment can be powered using an independent on-board battery supply so that deployment is possible away from standard utility service (e.g., in a field, forest, desert or hostile environment).

Another advantage provided by embodiments of the system is that the swing door of the case can store ancillary equipment like cables, batteries, mast poles, cross members, laptop computer, awning cables, ground stakes and/or fabric material for walls and awning. In addition, the case of the system can be used as a podium or laptop computer stand.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a rear perspective view of a particular illustrative embodiment of a system of enhanced integration of millimeter wave imagery;

FIG. 2 is a front view of a particular illustrative embodiment of the system of enhanced integration of millimeter wave imagery shown in FIG. 1;

FIG. 3 is a rear perspective view of another particular illustrative embodiment of a system of enhanced integration of millimeter wave imagery with internal storage;

FIG. 4 is a front perspective view of a particular illustrative embodiment of the system of enhanced integration of millimeter wave imagery with internal storage shown in FIG. 3;

FIG. 5 is a particular illustrative embodiment of a method of enhanced integration of millimeter wave imagery; and

FIG. 6 is a block diagram of a particular illustrative embodiment of a system of enhanced integration of millimeter wave imagery.

### V. DETAILED DESCRIPTION

A system of enhanced integration of millimeter wave imagery is disclosed. Several components, techniques, technologies and methodologies, including external millimeter wave energy mitigation, peripheral motion or clutter mitigation, test subject isolation, motion and flow control, threat containment, weather protection, decorative presentation, blast mitigation, and others may each be used separately, or in combination, with the system. The disclosed system 100 is comprised of equipment, components, techniques, designs and construction that separately or together provide an advantageous, predictable, portable, controlled and managed environment within which the millimeter wave camera operates optimally.

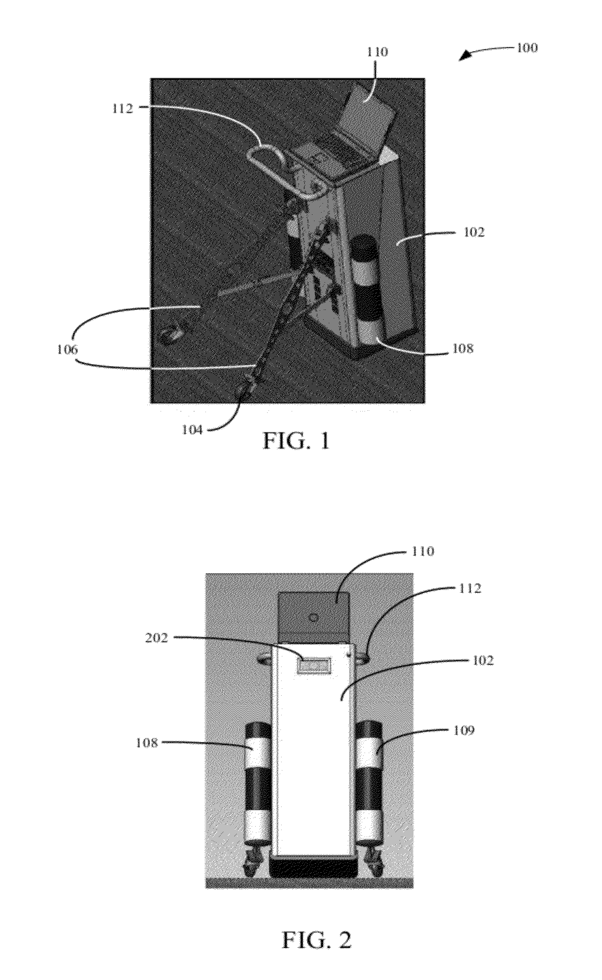

Referring now to FIGS. 1 and 2, the system is generally designated 100. The system 100 includes a case 102 having side walls about its periphery. A millimeter wave camera is contained within the case 102. The millimeter wave camera is configured to scan a target subject multiple times to generate millimeter wave imagery. The millimeter wave camera may operate in the 80 to 100 GHz range and is capable of automatically detecting a wide range of explosives, weapons, and other contraband including improvised explosive devices concealed under clothing. The millimeter wave camera may be equipped with a millimeter wave thirty-two pixel slot radiometer and utilize any number of pixels. Typically, the millimeter wave camera will utilize between sixteen and twenty-four of the pixel slots to increase the millimeter wave image resolution to approximately 1.6 inches by 1.6 inches. As part of the radiometer, a conical feedhorn is commonly used. Feedhorns are packed close together in the focal plane. The feedhorn defines the detector field of view and gives a tapered illumination of the scene. Maximum efficiency for the detection of a point source is achieved for a feedhorn diameter is close to 2 Fλ, where F is the focal ratio of the final optics and λ is the wavelength. To fully sample the image plane requires the feedhorn diameter and spacing to be 0.5 Fλ. Feedhorns are readily understood in terms of their control of the beam coupling, are easy to fabricate, and offer good rejection of electromagnetic interference as the feedhorn and detector cavity act as a Faraday enclosure. At least two scans of the target subject may be integrated to provide an increase of the resolution of the millimeter wave imagery when the target subject is not moving. For example, sixteen channels of the millimeter wave camera provides thirty-two samples in two scans of the target subject, where dithering the millimeter wave imagery by ¼ feed horn spacing increases the millimeter wave imagery to a sub-pixel resolution.

A top exterior portion of the case provides a surface to support a laptop personal computer 110. The laptop 110 provides a graphical user interface (GUI) to operate and control the millimeter wave camera and to display video and the millimeter wave imagery of the target subject. Alternatively, the video monitor may be a separate component. In operation, an operator stands behind the case 102 to view the video monitor and to use the laptop 110 to operate the equipment. The case 102 with external storage may be approximately sixteen inches in length, nineteen inches in width, and forty-five inches in height.

A pair of support arms 106 is disposed about a rear edge of the case 102. A distal end of each support arm 106 may include a wheel 104 as shown in FIGS. 1 and 2, but also may include rollers, spheres, and other similar configurations. The wheels 104 may be free-turning or electromechanically driven. An indoor and/or outdoor millimeter wave backdrop 108, 109 may be secured to the exterior sidewalls of the case 102 for transport. A handle 112 is located about an upper rear edge of the case 102 that can be used to push and direct the system 100 when delivering it to an installation. The handle 112 may also include controls for operating electromechanically driven wheels 104 to promote easy handling and increased portability. Accordingly, the system 100 provides an approach for deploying a millimeter wave camera system that is portable and highly mobile.

An aperture 202 is disposed on a front portion of the case 102 to allow millimeter wave energy to pass through to the millimeter wave camera as shown in FIG. 2. The support arms 106 may be extended outwards from a closed position to an extended position so that the bottom rear edge of the case 102 rests on the ground as illustrated in FIG. 1. Two leveling mounts may be located at the bottom front corners to stabilize the case 102. The leveling mounts may be fixed at a predetermined angle or adjustable for a variable angle. In another particular embodiment, the wheels 104 may be mounted directly to all four bottom corners of the case 102 or, alternatively, in a tricycle arrangement. The wheels 104 may also be recessed within case 102 to provide a smaller footprint.

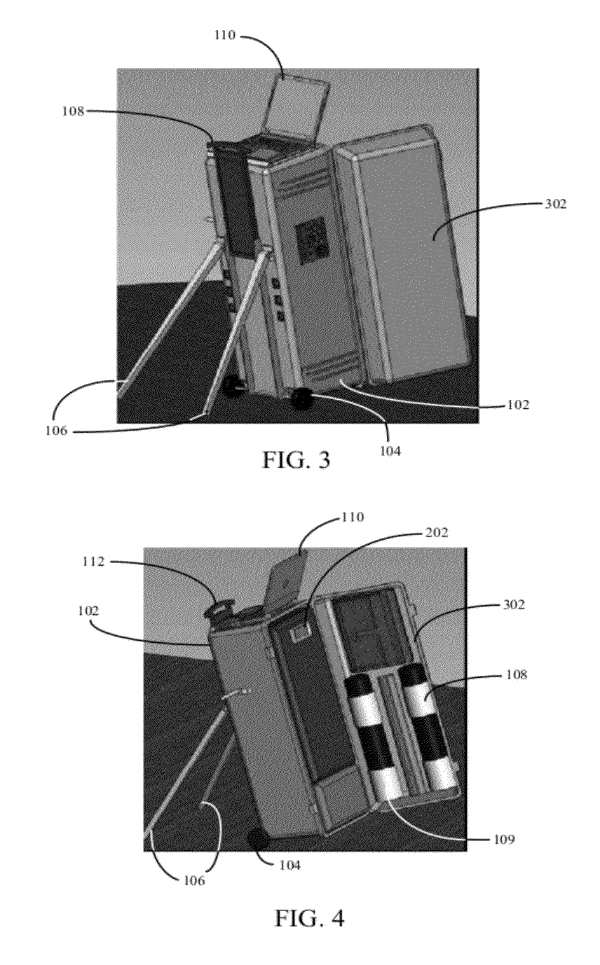

Referring now to FIG. 3, the case 102 may include a swing door 302 that may be hingedly connected to a longitudinal edge of the case 102 or the swing door 302 may be removable from the case 102 using fasteners or latches. As explained above, the wheels 104 may be secured to a rear edge of the case 102. The support arms 106 swing outwards from the case 102 to a selected angle relative to the case 102 to provide stability to the case 102 when in use. The support arms 306 pivot into and are stored adjacent to a rear surface of the case 102. The case 102 with a swing door 302 may be approximately twenty-five inches in length, fifteen inches in width, and forty-three inches in height. The case 102 is a self-contained high-impact plastic carrier suitable for shipping and long-term storage.

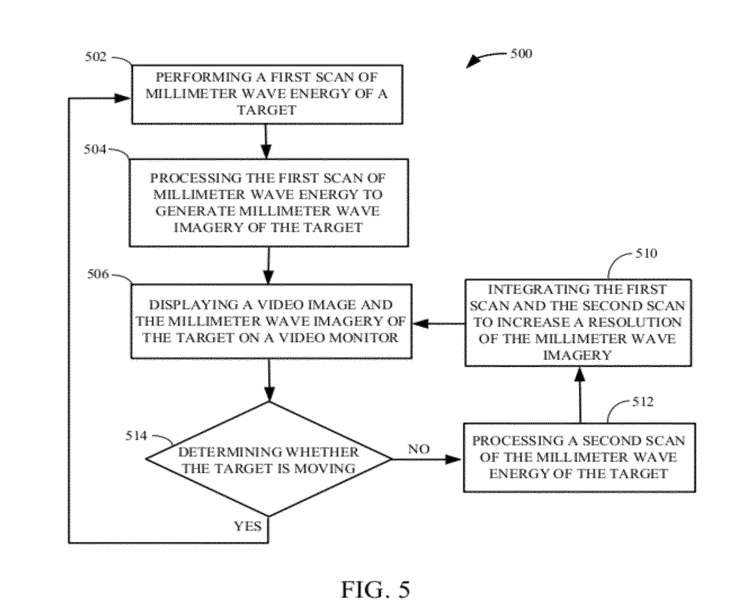

Referring now to FIG. 4, space within the swing door 302 can be used for storage of a laptop, video monitor, cabling such as power cords, intercom wiring, Ethernet cables, etc. An onboard processor may be used or a laptop computer 110 can be used as a remote monitoring station for the millimeter wave camera. Power for the system 100 may be supplied by an independent power supply such as an on-board battery (e.g., 12-volt batteries) using either disposable or rechargeable battery cells. Using a laptop 110 rather than an onboard processor saves weight, lowers power consumption, and reduces waste heat. A link for monitoring the millimeter wave camera to a laptop can be established by Ethernet cables or using a wireless Ethernet connection. The millimeter wave camera is mounted in a top portion inside the case 102 where the aperture 202 allows millimeter wave energy to pass through to the millimeter wave camera. The swing door 302 rotates to close over the equipment mounted within the case such as the millimeter wave camera and independent power supply as illustrated in FIG. 4. Space within the swing door 302 may also be used to store the indoor and/or outdoor millimeter wave backdrops 108, 109.

The case 102 may be positioned in proximity to an entry or exit of an inspection area such that the target subject traverses in front of the millimeter wave camera. Performance of the millimeter wave camera may be improved by providing the backdrop 108, 109 behind the target area where the backdrop may be flexible fabric used for ambient millimeter wave energy mitigation and reduction of peripheral visual/millimeter wave clutter. In a particular embodiment, the backdrops 108, 109 may be constructed of or coated with a material with blast mitigation properties such as Kevlar or Teflon.

To control the deployment environment, the backdrops 108, 109 are erected. Equipment to this effect (e.g., extendible members) may be stored inside the removable cover or inside a secondary container. The backdrops 108, 109 are secured using ground stakes, weights, or some other means to secure the backdrop from excessive movement when susceptible to high winds. The securement means may be either integral to the backdrops or separate. The inspection area is configured to contain and restrict the movement of subjects to be most advantageous of the millimeter wave camera's field of view, depth of field, optimum inspection distance and other properties.

In operation, the system of enhanced integration of millimeter wave imagery 100 begins with transporting the case 102 to the deployment site by virtue of its integrated portability features such as wheels 104 and handles 112. Once on site, the millimeter wave camera and video camera are positioned and leveled using adjustability on the wheels 104 and/or leveling mounts of the case 102. The system 100 is connected to a power source or can be optionally powered by an independent power source such as an onboard battery. The battery may have a plug-in charger. The target subject enters the inspection area and is required to stop and turn to be scanned by the system 100. The subject is allowed to continue out of the inspection area if no concealed object is detected. The entry and exit points of the inspection area may be separate at opposite ends of the inspection area or may be the same. An operator or other security personnel directs the next subject in the waiting line to stand approximately nine feet in front of the millimeter wave camera. The millimeter wave camera is continuously “on” and ready for scanning without human intervention. The subject is directed to raise his or her arms parallel with the floor or ground and slowly turn in a 360 degree circle. The operator views the video monitor (e.g., laptop) and detection is automatic with visual highlighting and warning or the operator may make a manual detection by observing the video monitor and interpreting the millimeter wave imagery. The subject is directed to proceed or, in the event of detection, the subject can be screened further in accordance with local security protocols. Three hundred people may be scanned by the system 100 per hour.

Referring to FIG. 5, a particular illustrative embodiment of a method of enhanced integration of millimeter wave imagery is disclosed and generally designated 500. A first scan of millimeter wave energy of a target is performed, at 502. Continuing to 504, the first scan is processed to generate millimeter wave imagery of the target. A video image and the millimeter wave imagery of the target are displayed on a video monitor, at 506. If the target is not moving, at 514, then a second scan is performed of the millimeter wave energy of the target. Moving to 510, the first scan and the second scan are integrated to increase a resolution of the millimeter wave imagery, at 510, and the video image and millimeter wave imagery are displayed, at 506. The millimeter wave imagery, video images and algorithmically created images with the computer generated highlights can be stored and accessed for playback and review.

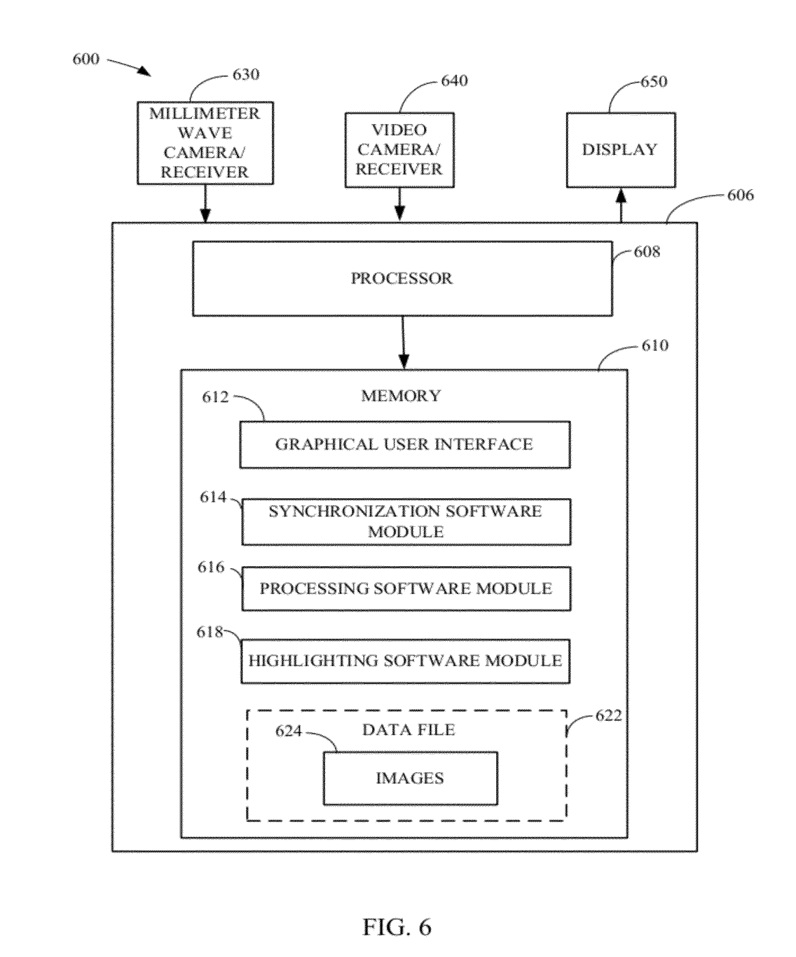

A block diagram of a particular embodiment of a system of enhanced integration of millimeter wave imagery is disclosed in FIG. 6 and generally designated 600. In a particular embodiment, the system 600 may be configured to perform the methods depicted in FIG. 5. The system 600 includes a device 606 having at least one processor 608 and a memory 610 that is accessible to the processor 608. The memory 610 includes media that is readable by the processor 608 and that stores data and program instructions of software modules that are executable by the processor 608, including a graphical user interface 612 for defining and controlling computer generated highlight indicators and/or annotations, a synchronization software module 614 for synchronizing the visible spectrum imagery, algorithmically created imagery, and the millimeter wave imagery, a processing software module 616 for generating the millimeter wave imagery, a highlighting software module 618 for overlaying the video and/or millimeter wave imagery with computer generated highlights coinciding with the location of a concealed object, and a data file 622 that includes recorded images 624. A millimeter wave camera and receiver 630, a video camera and receiver 640, and a display 650 are coupled to the device 606. In a particular embodiment, the graphical user interface 612 may include a keyboard, a pointing device, a touch screen, a speech interface, another device to receive user input, or any combination thereof.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A system of enhanced integration of millimeter wave imagery, the system comprising:
a case having side walls about its periphery;
a millimeter wave camera contained within the case, wherein the millimeter wave camera configured to scan a target subject multiple times to generate millimeter wave imagery; and
a video monitor to display the millimeter wave imagery of the target subject.

2. The system of claim 1, wherein the millimeter wave camera further configured to integrate at least two scans of the target subject to generate an enhanced millimeter wave imagery having an increase in resolution when the target subject is not moving.

3. The system of claim 2, further comprising an independent power source to provide power to the system.

4. The system of claim 3, wherein the case further comprising a handle disposed along a rear edge.

5. The system of claim 4, further comprising a rolling means disposed about a rear sidewall of the case and configured to roll the case.

6. The system of claim 5, wherein the millimeter wave camera further comprising a twenty-four pixel radiometer.

7. The system of claim 6, further comprising a personal computer in electrical communication with the millimeter wave camera and the video monitor.

8. The system of claim 7, wherein the resolution of the millimeter wave imagery is at least 1.6 inches by 1.6 inches.

9. The system of claim 8, further comprising at least one millimeter wave backdrop removably secured to the case and adapted to provide a contrast between the target subject and a background scene when installed behind the target subject.

10. The system of claim 9, wherein the case further comprising a swing door that opens to reveal the millimeter wave camera and a storage compartment.

11. A method of enhanced integration of millimeter wave imagery, the method comprising:
performing a first scan of millimeter wave energy of a target;
processing the first scan of millimeter wave energy to generate millimeter wave imagery of the target;
displaying a video image and the millimeter wave imagery of the target on a video monitor;
determining whether the target is still or moving;
processing a second scan of the millimeter wave energy of the target when the target is still and not moving; and
integrating the first scan and the second scan to increase a resolution of the millimeter wave imagery.

12. The method of claim 11, further comprising displaying the millimeter wave imagery on a graphical user interface (GUI).

13. The method of claim 12, further comprising displaying visible spectrum images on the graphical user interface, wherein the visible spectrum images are spatially and temporally relative to the millimeter wave imagery.

14. The method of claim 12, further comprising detecting the threat using the millimeter wave imagery.

15. The method of claim 14, further comprising overlaying the millimeter wave imagery with a computer generated highlight coinciding with a location of a detected threat.

16. A system of enhanced integration of millimeter wave imagery, the system comprising:
a processor for processing millimeter wave imagery;
a graphical user interface (“GUI”) to display the millimeter wave imagery; and
a highlighting software module for overlaying at least one of the millimeter wave imagery with a computer generated highlight coinciding with a location of a detected threat.

17. The system of claim 16, further comprising a processing software module for generating the millimeter wave imagery from the millimeter wave energy.

18. The system of claim 17, further comprising a memory device for recording the millimeter wave imagery to a data file.

19. The system of claim 18, further comprising a visible spectrum camera to correlate visible spectrum images with the millimeter wave imagery.

20. The system of claim 19, further comprising a synchronization software module to synchronize the millimeter wave imagery with the visible spectrum images.
